(19) United States
(12) Patent Application Publication
(10) Pub. No.: US 2009/0024425 A1
(43) Pub. Date: Jan. 22, 2009

(54) Methods, Systems, and Computer-Readable Media for Determining an Application Risk Rating

(76) Inventor: Robert Calvert, Alpharetta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/778,705

(22) Filed: Jul. 17, 2007

(51) Int. Cl. G06Q 10/00

(52) U.S. Cl. 705/7

(57) ABSTRACT

Methods, systems, and computer-readable media provide for determining an application risk rating. According to embodiments, a method for determining an application risk rating is provided. According to the method, a technology risk score is determined. The technology risk score indicates a technology status associated with a business system. A capacity risk score is determined. The capacity risk score indicates a capacity status associated with the business system. A business risk score is determined. The business risk score indicates a criticality of a function provided by the business system. An application risk rated is determined based on the technology risk score, the capacity risk score, and the business risk score.

### TECHNICAL FIELD

This application relates generally to the field of risk assessment. More specifically, the disclosure provided herein relates to the field of determining an application risk rating associated with a business system.

### BACKGROUND

Successful operation of a business generally involves properly balancing spending between maintenance and growth. Maintenance may include repairing and replacing existing business systems. In a first example, a business system may need to be replaced because vendor support has ended for the business system. In a second example, a business system may need to be repaired because a security flaw is found in the business system. In a third example, a business system, such as a server, may need to be replaced because the server is at or near capacity. In each of these examples and others, a determination can be made between allocating funds for repairing and/or replacing the business systems (i.e., maintenance) or for expenses to expand the business (i.e., growth). An example of growth spending is hiring additional employees or opening additional offices or branches.

Generally, decisions on allocating funds between maintenance and growth are made on-the-fly by a manager or other high-level employee of the organization. However, the manager may not be familiar enough with technology to determine if a business system needs to be repaired or replaced. For example, a decision on replacing an existing server providing payroll services with a larger, new server may be made quickly without much thought regarding future benefits or consequences. A decision to replace the existing server too soon may result in less money to allocate towards growth, while a decision to replace the existing server too late may result in significant downtime in which payroll services cannot be provided.

In many cases, the manager will make a decision based on a “gut feeling,” relying primarily on experience and education. Such reliance on gut feeling may result in incorrect, inconsistent, and unrepeatable decisions. In one example, while one manager may approve a particular spending measure, another manager may reject the same spending measure. In another example, due to unrelated business or personal distractions, a manager may reject a spending measure that he or she would approve in other instances. Such inconsistencies may be further exacerbated within larger organizations where the management of day-to-day operations is spread across many managers. Ultimately, an organization's bottom line may be affected if potentially critical decisions related to spending are left to the whim of the individual managers.

### SUMMARY

Embodiments of the disclosure presented herein include methods, systems, and computer-readable media for determining an application risk rating. According to one aspect, a method for determining an application risk rating is provided. According to the method, a technology risk score is determined. The technology risk score indicates a technology status associated with a business system. A capacity risk score is determined. The capacity risk score indicates a capacity status associated with the business system. A business risk score is determined. The business risk score indicates a criticality of a function provided by the business system. An application risk rating is determined based on the technology risk score, the capacity risk score, and the business risk score.

According to another aspect, a system for determining an application risk rating is provided. The system includes a memory and a processor functionally coupled to the memory. The memory stores a program containing code for determining an application risk rating. The processor is responsive to computer-executable instructions contained in the program and operative to determine a technology risk score indicating a technology status associated with a business system, determine a capacity risk score indicating a capacity status associated with the business system, determine a business risk score indicating a criticality of a function provided by the business system, and determine an application risk rating based on the technology risk score, the capacity risk score, and the business risk score.

According to yet another aspect, a computer-readable medium having instructions stored thereon for execution by a processor to perform a method for determining an application risk rating is provided. According to the method, a technology risk score is determined. The technology risk score indicates a technology status associated with a business system. A capacity risk score is determined. The capacity risk score indicates a capacity status associated with the business system. A business risk score is determined. The business risk score indicates a criticality of a function provided by the business system. An application risk rated rating is determined based on the technology risk score, the capacity risk score, and the business risk score.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating a system configured to determine an application risk rating, in accordance with exemplary embodiments.

FIG. 2 is a block diagram illustrating the application risk module, in accordance with exemplary embodiments.

FIG. 3 is a diagram illustrating a technology risk determination by a technology risk module, in accordance with exemplary embodiments.

FIG. 4 is a diagram illustrating a capacity risk determination by a capacity risk module, in accordance with exemplary embodiments.

FIG. 5 is a diagram illustrating a business risk determination by a business risk module, in accordance with exemplary embodiments.

FIG. 6 is a flow diagram illustrating a method for determining an application risk rating, in accordance with exemplary embodiments.

### DETAILED DESCRIPTION

The following detailed description is directed to methods, systems, and computer-readable media for determining an application risk rating. In the following detailed description, references are made to the accompanying drawings that form a part hereof, and which are shown by way of illustration specific embodiments or examples.

Embodiments described herein provide a methodology for determining risk to a business enterprise based on risk to an underlying application infrastructure of the enterprise. This type of risk is referred to herein as application risk. As used herein, an application refers to products, services, billing, marketing, payroll, and other regular operations of a given business enterprise. A business system may include one or more computing devices configured to provide the application. For example, a business system for providing payroll services may include a server computer executing payroll-related software. A business system may further include non-computing devices, such as facilities, personnel, and the like.

In one embodiment, the application risk is provided to a user as an application risk rating, which categorizes ranges of the application risk. For example, the application risk rating may categorize the application risk into one of three categories: “high” which indicates a high application risk, “medium” which indicates a medium application risk, and “low” which indicates a low application risk. As will be discussed below, it should be understood that the application risk rating may be categorized using any suitable scale including, but not limited to, numbers, letters, colors, sounds, and graphics. By simplifying the application risk to an objective application risk rating, a user, such as a manager, analyzing the application risk rating can more easily make accurate and prompt decisions (e.g., balancing funds between maintenance and growth) related to the application risk.

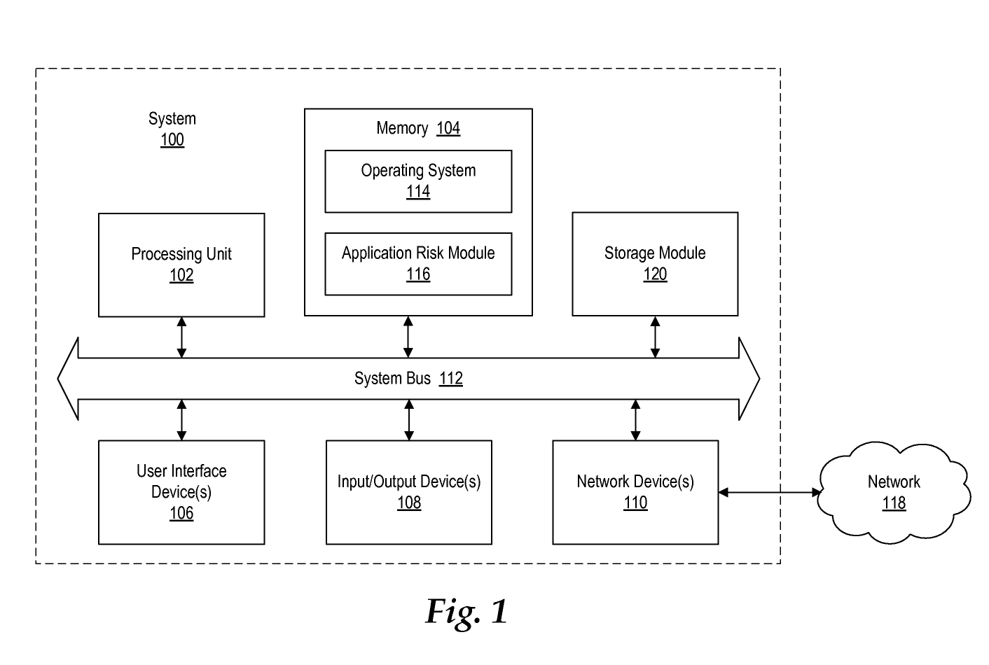

Referring now to the drawings, it is to be understood that like numerals represent like elements through the several figures, and that not all components and/or steps described and illustrated with reference to the figures are required for all embodiments. FIG. 1 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 1 is a block diagram illustrating a system 100 configured to determining an application risk rating, in accordance with exemplary embodiments. The system 100 includes a processing unit 102, a memory 104, one or more user interface devices 106, one or more input/output (“I/O”) devices 108, and one or more network devices 110, each of which is operatively connected to a system bus 112. The bus 112 enables bi-directional communication between the processing unit 102, the memory 104, the user interface devices 106, the I/O devices 108, and the network devices 110. Examples of the system 100 include, but are not limited to, computers, servers, personal digital assistants, cellular phones, or any suitable computing devices. The system may further include a storage module 120, commonly referred to as “disk space.” The storage module 120 may be directly attached to the system 100 or available through a shared network connection, such as a network 118.

The processing unit 102 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 104 communicates with the processing unit 102 via the system bus 112. In one embodiment, memory 104 is operatively connected to a memory controller (not shown) that enables communication with the processing unit 102 via the system bus 112. The memory 104 includes an operating system 114 and an application risk module 116, according to exemplary embodiments. Examples of operating systems, such as operating system 114, include, but are not limited to, WINDOWS operating system from MICROSOFT CORPORATION, LINUX operating system, and FREEBSD operating system. In one embodiment, the application risk module 116 is embodied in computer-readable media containing instructions that, when executed by the processing unit 102, performs a method for determining an application risk, as described in greater detail below. According to further embodiments, the application risk module 116 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the system 100.

The user interface devices 106 may include one or more devices with which a user accesses the system 100. The user interface devices 106 may include, but are not limited to, computers, servers, personal digital assistants, cellular phones, or any suitable computing devices. The I/O devices 108 enable a user to interface with the application risk module 116. In one embodiment, the I/O devices 108 are operatively connected to an I/O controller (not shown) that enables communication with the processing unit 102 via the system bus 112. The I/O devices 108 may include one or more input devices, such as, but not limited to, a keyboard, a mouse, or an electronic stylus. Further, the I/O devices 108 may include one or more output devices, such as, but not limited to, a display screen or a printer.

The network devices 110 enable the system 100 to communicate with other networks or remote systems via a network 118. Examples of network devices 110 may include, but are not limited to, a modem, a radio frequency (“RF”) or infrared (“IR”) transceiver, a telephonic interface, a bridge, a router, or a network card. The network 118 may include a wireless network such as, but not limited to, a Wireless Local Area Network (“WLAN) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 118 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

The storage module 120 may include one or more disk drives containing a suitable amount of longer term file storage. The storage module 120 may be directly attached to the system 100 via the system bus 112, as illustrated in the example shown in FIG. 1. In further embodiments, the storage module 120 may be at least an allocated portion of an external storage device accessible via the network 118. The storage module 120 may store program executables, library code (e.g., dynamic-link library (“DLL”)), and other suitable data for enabling proper execution of the system 100. The storage module 120 may further store one or more databases, for which functionality may be provided via commercial off-the-shelf (“COTS”) and/or custom-developed software, hardware, firmware, and the like. Examples of databases may include, but are not limited to ORACLE from ORACLE CORPORATION and SQL SERVER from MICROSOFT CORPORATION. The storage module 120 of the system 100 may be routinely backed up so that data stored in the storage module 120 may be restored for disaster recovery, business continuity, or other suitable purposes.

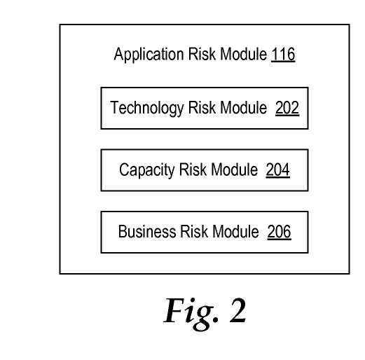

FIG. 2 is a block diagram illustrating the application risk module 116, in accordance with exemplary embodiments. According to exemplary embodiments, the application risk module 116 determines an application risk rating, which provides an objective measure of the potential for negative business consequences arising from foreseeable but unplanned or unmitigated events that affect the business systems, and consequently the applications provided by the business systems, on which a business enterprise relies. The application risk module 116 includes a technology risk module 202, a capacity risk module 204, and a business risk module 206, according to exemplary embodiments.

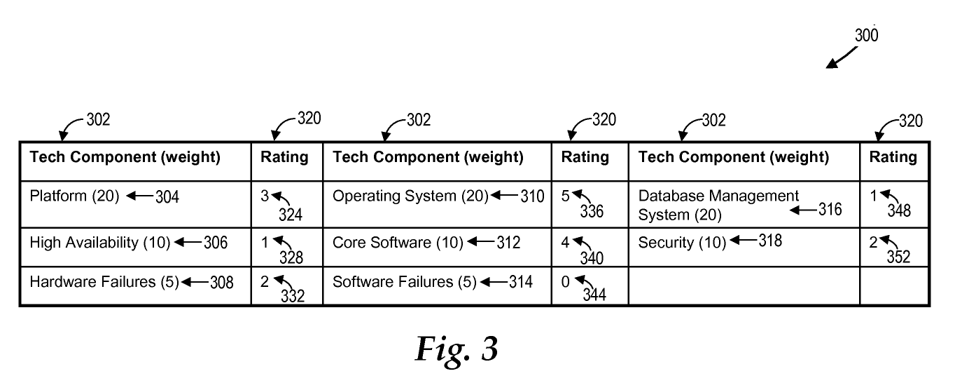

According to exemplary embodiments, the technology risk module 202 provides a technology risk score as an objective measure of a technology risk to a given business system based on technology components on which the business system is built. A rise in the technology risk may indicate a need to upgrade, replace, repair, and/or re-platform the business system. The technology risk may rise because the technology components have become outdated or unsupportable by, for example, a vendor of the technology component. Exemplary technology components include, but are not limited to, platforms (e.g., hardware), operating systems, database management systems, core software, high availability tools (e.g., automatic failover systems), and security tools. Further, the technology risk may rise because of frequent hardware and/or software failures, as well as the exposure of exploitable security flaws in the business system. As described in greater detail below with respect to FIG. 3, the technology risk module 202 may determine a technology risk score based on a technology risk rating, such as technology risk ratings 324, 328, 332, 336, 340, 344, 348, 352 and a technology risk weighting related to each of a plurality of technology components, such as technology components 304, 306, 308, 310, 312, 314, 316, 318.

Referring to FIG. 3, an exemplary diagram 300 illustrating a technology risk determination by the technology risk module 202 is shown, in accordance with exemplary embodiments. The diagram 300 includes a technology components column 302 related to a given business system, such as a server. In one embodiment, the technology components column 302 includes a platform component 304, a high availability component 306, a hardware failures component 308, an operating system component 310, a core software component 312, a software failures component 314, a database management system component 316, and a security component 318. It will be appreciated by those of skilled in the art that the technology components 304, 306, 308, 310, 312, 314, 316, 318 illustrated in FIG. 3 are only exemplary. The diagram 300 may include additional or different technology components depending on the business system being analyzed, according to further embodiments.

According to the example illustrated in FIG. 3, related to each of the technology components 304, 306, 308, 310, 312, 314, 316, 318, is the technology risk weighting (shown in FIG. 3 in parentheses) and the technology risk rating 324, 328, 332, 336, 340, 344, 348, 352 in a technology risk ratings column 320. The technology risk weighting may indicate the importance of the particular technology component 304, 306, 308, 310, 312, 314, 316, 318 in the determination of the technology risk score, as described in greater detail below. For example, a higher technology risk weighting may indicate a greater importance of the technology component 304, 306, 308, 310, 312, 314, 316, 318 with respect to the business system, while a lower risk weighting may indicate a decreased importance of the technology component 304, 306, 308, 310, 312, 314, 316, 318. In one embodiment, the technology risk weighting for each of the technology components 304, 306, 308, 310, 312, 314, 316, 318 of the given business system adds up to 100. The technology risk rating 324, 328, 332, 336, 340, 344, 348, 352 may indicate a technology risk associated with each of the technology components 304, 306, 308, 310, 312, 314, 316, 318. For example, a higher technology risk rating 324, 328, 332, 336, 340, 344, 348, 352 may indicate that the technology component 304, 306, 308, 310, 312, 314, 316, 318 should be upgraded, replaced, repaired, and/or re-platformed, while a lower technology risk rating 324, 328, 332, 336, 340, 344, 348, 352 may indicate that the technology component 304, 306, 308, 310, 312, 314, 316, 318 is currently functional and/or supportable. In one embodiment, the technology risk rating 324, 328, 332, 336, 340, 344, 348, 352 is a number between zero and five, with zero indicating the lowest technology risk and five indicating the highest technology risk.

According to exemplary embodiments, the platform component 304 indicates a hardware technology risk. In the example illustrated in FIG. 3, the platform component 304 has a technology risk weighting of twenty and a technology risk rating 324 of three. The high availability component 306 indicates an availability of a back-up system. The high availability component 306 has a technology risk weighting of ten and a technology risk rating 328 of one. The hardware failures component 308 indicates a hardware failure risk based on past hardware failures. The hardware failures component 308 has a technology risk weighting of twenty and a technology risk rating 332 of five. The platform component 304 generally refers to the core hardware with respect to its age, version, upgradeability, and the like. The hardware failures component 308 generally refers to a history of component breakage. For example, while an older processor board may be at risk due to sparse availability of spare parts in the event of a failure, a newer processor board with a history of failures may be even riskier.

The operating system component 310 indicates an operating system technology risk. For example, an older operating system may have a higher technology risk than a newer operating system. The operating system component 310 has a technology risk weighting of twenty and a technology risk rating 336 of five. The core software component 312 indicates a software technology risk. The core software component 312 has a technology risk weighting of ten and a technology risk rating 340 of four. The software failures component 314 indicates a software failure risk based on past software failures. The software failures component 314 has a technology risk weighting of five and a technology risk rating 344 of zero. The core software component 312 generally refers to the cores software with respect to its age, version, available support for bug fixes, patches and the like. The software failures component 314 generally refers to the history of a given piece of code. For example, an older version of a database may be functional but not patchable (i.e., bugs found cannot be fixed), while a brand new software component may have excessive bugs due to poor quality testing. In general, the core software component 312 refers to supportability, and the software failures component 314 refers to the probability of future failure.

The database management system component 316 indicates a database management system technology risk. The database management system component 316 has a technology risk weighting of twenty and technology risk rating 348 of one. The security component 318 indicates an exploitable security risk. The security component 318 has a technology risk weighting of ten and a technology risk rating 352 of two. According to this example, the technology risk weightings add up to 100, and the technology risk ratings 324, 328, 332, 336, 340, 344, 348, 352 are each a number between zero and five.

The technology risk score may be determined based on the technology risk weightings and the technology risk ratings 324, 328, 332, 336, 340, 344, 348, 352 associated with each of the technology components 304, 306, 308, 310, 312, 314, 316, 318. In one embodiment, the technology risk score is determined by multiplying the technology risk weighting by the technology risk rating 324, 328, 332, 336, 340, 344, 348, 352 for each of the technology components 304, 306, 308, 310, 312, 314, 316, 318, summing the results from the multiplication to determine an aggregate score, and dividing the aggregate score by 100 to determining a weighted average. This weighted average is the technology risk score, according to one embodiment. In this embodiment, the technology risk score is a number between zero and five. With respect to the example shown in FIG. 3, the technology risk score is 2.6 (i.e., ((3*20)+(5*20)+(1*20)+(1*10)+(4*10)+(2*10)+(2×5)+(0*5))/100=260/100=2.6). As described in greater detail below, the technology risk score may be used to determine the application risk rating.

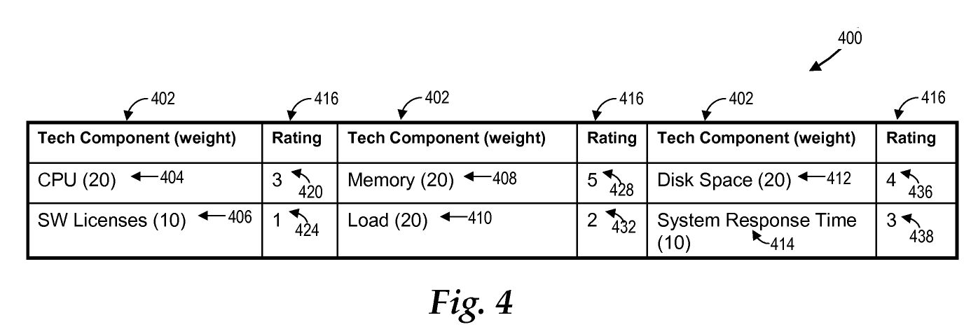

Referring again to FIG. 2, the capacity risk module 204 provides a capacity risk score as an objective measure of a capacity risk to a given business system based on current usage and growth potential, according to exemplary embodiments. A rise in the capacity risk may indicate a need to replace, upgrade, or expand the business system to handle additional capacity. The capacity risk may rise because consumable, computing resources (i.e., capacity components) related to the business system have become insufficient to handle current or future utilization. Exemplary consumable, computing resources include, but are not limited to, a central processing unit (“CPU”), memory usage, disk storage, and network bandwidth. Further, the capacity risk may rise because of licensing restrictions related to software executed by the business systems, as well as the ability of the current architecture of the business system to handle current and/or future load demands. Additionally, system response time, as perceived by users of the system 100, may be classified as at least part of the capacity risk. Licensing restrictions generally limit a number of users allowed to use the software. The limitations of the current architecture may decrease throughput and response times during periods of increased load demands. As described in greater detail below with respect to FIG. 4, the capacity risk module 204 may determine a capacity risk score based on a capacity risk rating, such as capacity risk ratings 420, 424, 428, 432, 436, 438, and a capacity risk weighting related to each of a plurality of capacity components 404, 406, 408, 410, 412, 414. The capacity components 404, 406, 408, 410, 412, 414 may overlap or be mutually exclusive with the technology components 304, 306, 308, 310, 312, 314, 316, 318, according to embodiments.

Referring to FIG. 4, an exemplary diagram 400 illustrating a capacity risk determination by the capacity risk module 204 is shown, in accordance with exemplary embodiments. The diagram 400 includes a capacity components column 402 related to a given business system, such as a server. In one embodiment, the capacity components column 402 includes a CPU component 404, a software license component 406, a memory component 408, load component 410, a disk space component 412, and a system response time component 414. It will be appreciated by those of skilled in the art that the capacity components 404, 406, 408, 410, 412, 414 illustrated in FIG. 4 are only exemplary. The diagram 400 may include additional or different capacity components, such as a bandwidth component (not shown) indicating a bandwidth risk, depending on the business system being analyzed, according to further embodiments.

According to the example illustrated in FIG. 4, related to each of the capacity components 404, 406, 408, 410, 412, 414 is the capacity risk weighting (shown in FIG. 3 in parentheses) and the capacity risk rating 420, 424, 428, 432, 436, 438 in a capacity risk ratings column 416. The capacity risk weighting may indicate the importance of the particular capacity component 404, 406, 408, 410, 412, 414 in the determination of the capacity risk score, as described in greater detail below. For example, a higher capacity risk weighting may indicate a greater importance of the capacity component 404, 406, 408, 410, 412, 414 with respect to the business system, while a lower capacity risk weighting may indicate a decreased importance of the capacity component 404, 406, 408, 410, 412, 414. In one embodiment, the capacity risk weighting for each of the capacity components 404, 406, 408, 410, 412, 414 of the given business system adds up to 100. The capacity risk rating 420, 424, 428, 432, 436, 438 may indicate a capacity risk associated with each of the capacity components 404, 406, 408, 410, 412, 414. For example, a higher capacity risk rating 420, 424, 428, 432, 436, 438 may indicate that the capacity component 404, 406, 408, 410, 412, 414 should be replaced, upgraded, and/or expanded, while a lower capacity risk rating 420, 424, 428, 432, 436, 438 may indicate that the capacity component 404, 406, 408, 410, 412, 414 meets current and/or future capacity needs. In one embodiment, the capacity risk rating 420, 424, 428, 432, 436, 438 is a number between zero and five, with zero indicating the lowest capacity risk and five indicating the highest capacity risk.

According to exemplary embodiments, the CPU component 404 indicates a CPU capacity risk. According to the example illustrated in FIG. 4, the CPU component 404 has a capacity risk weighting of twenty and a capacity risk rating 420 of three. The software license component 406 indicates a software license capacity risk. The software license component 406 has a capacity risk weighting of ten and a capacity risk rating 424 of one. The memory component 408 indicates a memory capacity risk. The memory component 408 has a capacity risk weighting of twenty and a capacity risk rating 428 of five. The load component 410 indicates a load demand capacity risk. The load component 410 has a capacity risk weighting of twenty and a capacity risk rating 432 of two. The disk space component 412 indicates a disk space (e.g., a hard disk drive) capacity risk. The disk space component 412 has a capacity risk weighting of twenty and a capacity risk rating 436 of four. The system response time component 414 has a capacity risk weighting of ten and a capacity risk rating 438 of three. According to this example, the capacity risk weightings add up to 100, and the capacity risk ratings 420, 424, 428, 432, 436, 438 are each a number between zero and five.

The capacity risk score may be determined based on the capacity risk weightings and the capacity risk ratings 420, 424, 428, 432, 436, 438 associated with each of the capacity components 404, 406, 408, 410, 412, 414. In one embodiment, the capacity risk score is determined by multiplying the capacity risk weighting by the capacity risk rating 420, 424, 428, 432, 436, 438 for each of the capacity components 404, 406, 408, 410, 412, 414, summing the results from the multiplication to determine an aggregate score, and dividing the aggregate score by 100 to determine a weighted average. This weighted average is the capacity risk score, according to one embodiment. In this embodiment, the technology risk score is a number between zero and five. With respect to the example shown in FIG. 4, the technology risk score is 3.0 (i.e., (3*20)+(5*20)+(4*20)+(1*10)+(2*20)+(3*10))/100=320/100=3.2). As described in greater detail below, the capacity risk score may be used to determine the application risk rating.

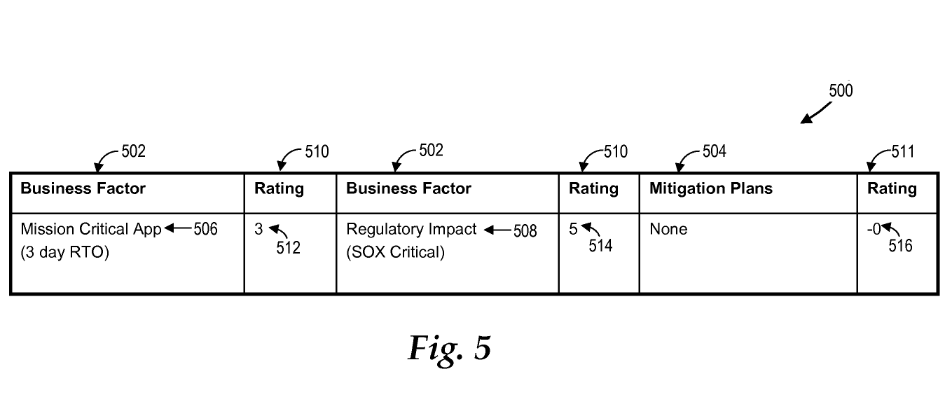

Referring again to FIG. 2, the business risk module 206 provides a business risk score as an objective measure of business risk based on the criticality of a function that a given business system provides. In particular, the business risk may be based on the severity of consequences (e.g., lost business, idle employee time, inability to deliver product or service, penalties arising from inability to meet legal and/or regulatory requirements) resulting from the business system ceasing to provide the function. Exemplary functions provided by the business system include, but are not limited to, payroll, billing, and product and service deployment. A higher business risk may indicate that the function provided by the business system is of higher criticality, while a lower business risk may indicate that the function provided by the business system is of lower criticality. The criticality of a function may be based on any suitable business factors, such as costs an organization would assume if the business system ceases operation, as well potential penalties associated with legal and regulatory requirements. Exemplary legal and regulatory requirements include, but are not limited to, the Sarbanes-Oxley Act, Federal Communications Commission (“FCC”) regulations, and Securities Exchange Commission (“SEC”) regulations. In one embodiment, the business risk is mitigated by one or more mitigation factors. For example, if a business system is in decline and is expected not to be necessary in the near future, then the business risk related to the business system may be reduced. As described in greater detail below with respect to FIG. 5, the business risk module 206 may determine a business risk score based on a business risk rating, such as business risk ratings 512, 514 related to each business factor, such as business factors 506, 508, and mitigation ratings 516 related to each mitigation factor. Although not illustrated in FIG. 5, the business risk ratings 512, 514 related to each business factor 506, 508 and the mitigation ratings 516 related to each mitigation factor may be weighted according to the importance of the given business factor or mitigation factor.

Referring to FIG. 5, an exemplary diagram 500 illustrating a business risk determination by the business risk module 206 is shown, in accordance with exemplary embodiments. The diagram 500 includes a business factor column 502 related to a given business system, such as a server, and a mitigation factor column 504. In one embodiment, the business factor column 502 includes a mission critical factor 506 and a regulatory impact factor 508, and the mitigation factor column 504 includes no mitigation factors. It will be appreciated by those of skilled in the art that the business factor column 502 and the mitigation factor column 504 illustrated in FIG. 5 are only exemplary. The diagram 500 may include additional or different mitigation factors and/or business factors, such as a legal impact factor (not shown) indicating a legal impact if the business system ceases to operate, or a change in the competitive business climate, depending on the business system being analyzed, according to further embodiments.

As illustrated in the example shown in FIG. 5, related to each of the business factors 506, 508 is the business risk rating 512, 514 under a business risk rating column 510. The business risk rating 512, 514 may indicate the criticality of the particular business factor in the business factor column 502, as described in greater detail below. For example, a higher business risk rating 512, 514 may indicate a greater consequence if the business system were to cease operation, while a lower business risk rating 512, 514 may indicate a lesser consequence if the business system were to cease operation. In one embodiment, the business risk rating 512, 514 is a number between zero and five, with zero indicating the lowest business risk and five indicating the highest business risk.

Although no mitigation factors are illustrated in FIG. 5, the mitigation factor column 504 may include one or more mitigation factors, according to further embodiments. As illustrated in the example shown in FIG. 5, the mitigation rating 516 is zero under a mitigation rating column 511 because the mitigation factor column 504 includes no mitigation factors. As described in greater detail below, the mitigation rating 516 may be subtracted from the business risk ratings 512, 514 to determine a business risk score.

According to exemplary embodiments, the mission critical factor 506 indicates the criticality of the function provided by the business system with respect to the organization. As illustrated in the example shown in FIG. 5, the mission critical factor 506 specifies a three-day recovery time objective (“RTO”) in which the business system is to be restored if the business system ceases to operate. The mission critical factor 506 has a business risk rating 512 of three. According to exemplary embodiments, the regulatory impact factor 508 indicates the criticality of the function provided by the business system with respect to regulatory requirements. As illustrated in the example shown in FIG. 5, the regulatory impact factor 508 specifies that the function provided by the business system may be critical with respect to the Sarbanes-Oxley Act. The regulatory impact factor 508 has a business risk rating 514 of five. The mitigation factor column 504 includes no mitigation factors which correspond to the mitigation rating 516 of zero. According to this example, the business risk ratings 512, 514 and the mitigation rating 516 are each a number between zero and five.

The business risk score may be determined based on the business risk ratings 512, 514 and the mitigation rating 516. In one embodiment, the business risk score is determined by selecting the highest business risk rating 512, 514 from the business risk rating column 510 and applying any aligned mitigation ratings 516 from the mitigation rating column 511. The mitigation ratings 516 may reduce one or more of the business factors 506, 508. As such, the mitigation ratings 516 may not reduce the highest business risk rating 512, 514 that is selected. For example, a mitigating rating 516 indicating that a given system is replaced in one year may mitigate the mission critical factor 506, but may not mitigate the regulatory impact factor 508. In this embodiment, the business risk score is a number between negative five and five. As illustrated in the example shown in FIG. 5, the business risk score is 5.0 (i.e., selecting the highest business risk rating 514 of five and subtracting any aligned mitigation rating 516 of zero). As described in greater detail below, the business risk score may be used to determine the application risk rating.

According to exemplary embodiments, the application risk rating is determined using any combination of the technology risk score, the capacity risk score, and the business risk score. The application risk rating may be determined based on a simple average or a weighted average of the technology risk score, the capacity risk score, and the business risk score. For example, averaging the technology risk score of 2.6 from FIG. 3, the capacity risk score of 3.2 from FIG. 4, and the business risk score 5.0 from FIG. 5 results in an application risk rating of 3.6.

In one embodiment, the application risk rating is categorized for easy analysis. For example, a range between zero and two may indicate a low application risk, a range between two and three may indicate medium application risk, and a range between three and five may indicate high application risk. Using this example, the application risk rating of 3.6 as determined above would indicate a high application risk. The high application risk category may be presented to a user via an output device, such as a display or a printer. In further embodiments, the application risk rating may be displayed as a gauge graphic or other suitable media.

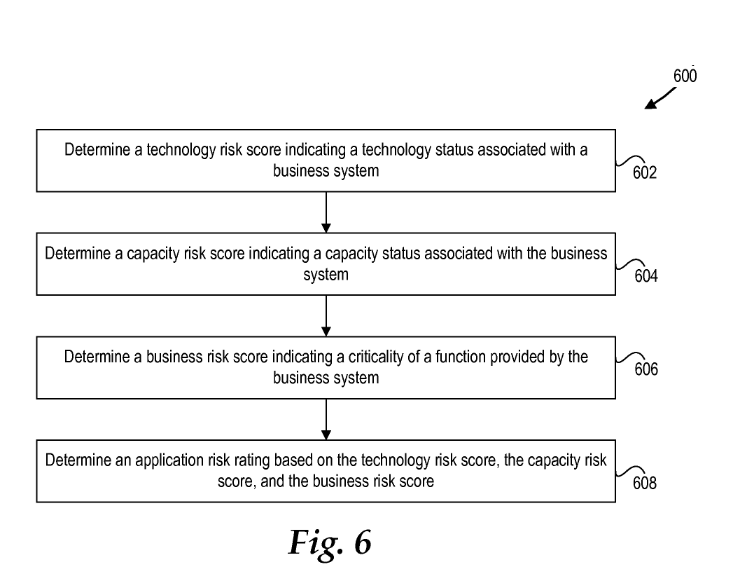

FIG. 6 is a flow diagram illustrating a method 600 for determining an application risk rating, according to exemplary embodiments. The technology risk module 202 determines (at 602) a technology risk score. According to exemplary embodiments, the technology risk score indicates a technology status (i.e., a need to repair, replace, and/or otherwise address a technology-related issue) associated with a business system. As described in greater detail above, the technology risk score may be determined based on the technology risk weightings and the technology risk ratings 324, 328, 332, 336, 340, 344, 348, 352 associated with each of the technology components 304, 306, 308, 310, 312, 314, 316, 318. In one embodiment, the technology risk score is a weighted average of the technology risk ratings 324, 328, 332, 336, 340, 344, 348, 352 with respect to the technology risk weightings associated with each of the technology components 304, 306, 308, 310, 312, 314, 316, 318.

The capacity risk module 204 determines (at 604) a capacity risk score. According to exemplary embodiments, the capacity risk score indicates a capacity status (i.e., a need to expand, upgrade, and/or otherwise address a capacity-related issue) associated with the business system. As described in greater detail above, the capacity risk score may be determined based on the capacity risk weightings and the capacity risk ratings 420, 424, 428, 432, 436, 438 associated with each of the capacity components 404, 406, 408, 410, 412, 414. In one embodiment, the capacity risk score is a weighted average of the capacity risk ratings 420, 424, 428, 432, 436, 438 with respect to the capacity risk weightings associated with each of the capacity components 404, 406, 408, 410, 412, 414.

The business risk module 206 determines (at 606) a business risk score. According to exemplary embodiments, the business risk score indicates a criticality of a function provided by the business system. As described in greater detail above, the business risk score may be determined based on the capacity risk ratings 512, 514 of the business factors and the mitigation ratings 516 of the mitigation factors. In one embodiment, the business risk score is determined by selecting the highest capacity risk rating in the capacity risk ratings 512, 514 of the business factors, selecting the highest mitigation rating in the mitigation ratings 516, after subtracting any aligned mitigation rating.

The application risk module 116 determines (at 608) an application risk rating based on the technology risk score, the capacity risk score, and the business risk score. The application risk rating may be determined based on a simple average or a weighted average of the technology risk score, the capacity risk score, and the business risk score Further, the application risk rating may assigned to a category (e.g., high risk, medium risk, low risk) for easy analysis by a user.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for determining an application risk rating, comprising:
determining a technology risk score indicating a technology status associated with a business system;
determining a capacity risk score indicating a capacity status associated with the business system;
determining a business risk score indicating a criticality of a function provided by the business system; and
determining the application risk rating based on the technology risk score, the capacity risk score, and the business risk score.

2. The method of claim 1, wherein determining a technology risk score indicating a technology status associated with a business system comprises:
determining a technology risk rating for each of a plurality of technology components associated with the business system, the technology risk rating indicating a criticality of each of the plurality of technology components;
determining a technology risk weighting for each of the plurality of technology components, the technology risk weighting indicating an importance of each of the plurality of technology components with respect to others of the plurality of technology components; and
determining the technology risk score based on the technology risk ratings and the technology risk weightings for the plurality of technology components.

3. The method of claim 1, wherein determining a capacity risk score indicating a capacity status associated with the business system comprises:
determining a capacity risk rating for each of a plurality of capacity components associated with the business system, the risk rating indicating a criticality of each of the plurality of capacity components;
determining a capacity risk weighting for each of the plurality of capacity components, the capacity risk weighting indicating an importance of each of the plurality of capacity components with respect to others of the plurality of capacity components; and
determining the capacity risk score based on the capacity risk ratings and the capacity risk weightings for the plurality of capacity components.

4. The method of claim 1, wherein determining a business risk score indicating a criticality of a function provided by the business system comprises:
determining a business risk rating for each of a plurality of business factors associated with the business system, the business risk rating indicating a criticality of each of the plurality of business factors; and
determining the business risk score based on the business risk rating.

5. The method of claim 4, wherein the business risk score is decreased according to at least one mitigation factor.

6. The method of claim 1, wherein determining an application risk rating based on the technology risk score, the capacity risk score, and the business risk score comprises determining an average of the technology risk score, the capacity risk score, and the business score.

7. The method of claim 1, further comprising:
displaying the application risk rating according to one of a high application risk, a medium application risk, and a low application risk.

8. A system for determining an application risk rating, comprising:
a memory for storing a program containing code for determining an application risk rating;
a processor functionally coupled to the memory, the processor being responsive to computer-executable instructions contained in the program and operative to:
determine a technology risk score indicating a technology status associated with a business system,
determine a capacity risk score indicating a capacity status associated with the business system,
determine a business risk score indicating a criticality of a function provided by the business system, and
determine the application risk rating based on the technology risk score, the capacity risk score, and the business risk score.

9. The system of claim 8, wherein to determine a technology risk score indicating a technology status associated with a business system, the processor is further operative to:
determine a technology risk rating for each of a plurality of technology components associated with the business system, the technology risk rating indicating a criticality of each of the plurality of technology components,
determine a technology risk weighting for each of the plurality of technology components, the technology risk weighting indicating an importance of each of the plurality of technology components with respect to others of the plurality of technology components, and
determine the technology risk score based on the technology risk ratings and the technology risk weightings for the plurality of technology components.

10. The system of claim 8, wherein to determine a capacity risk score indicating a capacity status associated with the business system, the processor is further operative to:
determine a capacity risk rating for each of a plurality of capacity components associated with the business system, the capacity risk rating indicating a criticality of each of the plurality of capacity components,
determine a capacity risk weighting for each of the plurality of components, the capacity risk weighting indicating an importance of each of the plurality of capacity components with respect to others of the plurality of capacity components, and
determine the capacity risk score based on the capacity risk ratings and the capacity risk weightings for the plurality of capacity components.

11. The system of claim 8, wherein to determine a business risk score indicating a criticality of a function provided by the business system, the processor is further operative to:
determine a business risk rating for each of a plurality of business factors associated with the business system, the business risk rating indicating a criticality of each of the plurality of business factors, and
determine the business risk score based on the business risk rating.

12. The system of claim 11, wherein the business risk score is decreased according to at least one mitigation factor.

13. The system of claim 8, wherein to determine an application risk rating based on the technology risk score, the capacity risk score, and the business risk score, the processor is further operative to:
determine an average of the technology risk score, the capacity risk score, and the business score.

14. A computer-readable medium having instructions stored thereon for execution by a processor to perform a method for determining an application risk rating, the method comprising:
determining a technology risk score indicating a technology status associated with a business system;
determining a capacity risk score indicating a capacity status associated with the business system;
determining a business risk score indicating a criticality of a function provided by the business system; and
determining the application risk rating based on the technology risk score, the capacity risk score, and the business risk score.

15. The computer-readable medium of claim 14, wherein determining a technology risk score indicating a technology status associated with a business system comprises:
determining a technology risk rating for each of a plurality of technology components associated with the business system, the technology risk rating indicating a criticality of each of the plurality of technology components;
determining a technology risk weighting for each of the plurality of technology components, the technology risk weighting indicating an importance of each of the plurality of technology components with respect to others of the plurality of technology components; and
determining the technology risk score based on the technology risk ratings and the technology risk weightings for the plurality of technology components.

16. The computer-readable medium of claim 14, wherein determining a capacity risk score indicating a capacity status associated with the business system comprises:
determining a capacity risk rating for each of a plurality of capacity components associated with the business system, the risk rating indicating a criticality of each of the plurality of capacity components;
determining a capacity risk weighting for each of the plurality of capacity components, the capacity risk weighting indicating an importance of each of the plurality of capacity components with respect to others of the plurality of capacity components; and
determining the capacity risk score based on the capacity risk ratings and the capacity risk weightings for the plurality of capacity components.

17. The computer-readable medium of claim 14, wherein determining a business risk score indicating a criticality of a function provided by the business system comprises:
determining a business risk rating for each of a plurality of business factors associated with the business system, the business risk rating indicating a criticality of each of the plurality of business factors; and
determining the business risk score based on the business risk rating.

18. The computer-readable medium of claim 17, wherein the business risk score is decreased according to at least one mitigation factor.

19. The computer-readable medium of claim 14, wherein determining an application risk rating based on the technology risk score, the capacity risk score, and the business risk score comprises determining an average of the technology risk score, the capacity risk score, and the business score.

20. The computer-readable medium of claim 14, the method further comprising:
displaying the application risk rating according to one of a high application risk, a medium application risk, and a low application risk.
